(19) United States
(12) Patent Application Publication
(10) Pub. No.: US 2013/0279597 A1
(43) Pub. Date: Oct. 24, 2013

(54) APPARATUSES AND METHODS FOR BITSTREAM BITSTUFFING

(71) Applicant: ERIC C. PEARSON, Conestogo (CA)

(72) Inventor: ERIC C. PEARSON, Conestogo (CA)

(73) Assignee: Magnum Semiconductor, Inc., Milpitas, CA (US)

(21) Appl. No.: 13/454,669

(22) Filed: Apr. 24, 2012

(51) Int. Cl. H04N 7/26

(52) U.S. Cl. 375/240.24; 375/240.26; 375/240.25; 375/E07.027; 375/E07.198

(57) ABSTRACT

Examples of methods and apparatuses for inserting and removing stuffing data in a bitstream described. An encoding system may include an encoder configured to receive a video signal and stuffing data. The encoder may be configured encode the video signal in accordance with an encoding methodology and provide a bitstream based on the encoded video signal and the stuffing data. The stuffing data may include random and/or encrypted data. A decoder may receive a bitstream and remove stuffing data from the bitstream. The decoder may include a padding removal apparatus that may include a slice detection block and a bitstream editor. The slice detection block may be configured to determine locations of stuffing data in a bitstream and provide the locations to the bitstream editor using control signals. The bitstream editor may be configured to remove the stuffing data based on the control signals.

### TECHNICAL FIELD

Embodiments of the invention relate generally to video encoding, and more specifically, to bitstream bitstuffing.

### BACKGROUND

Various video encoding standards have been established for encoding video signals. The Moving Picture Experts Group (MPEG), for example, has developed standards including MPEG-1, MPEG-2 and MPEG-4. Other examples include the International Telecommunication Union (ITU)-T H.263 standard, and the more recent ITU-T H.264 standard. These video encoding standards provide improved transmission rates of video sequences by encoding and/or compressing baseband video signals.

Improved display and video capture capabilities have led to higher bit rate video signals, and as a result the importance for encoding has increased, particularly with respect to video broadcasting, where encoders can reduce channel capacity required to provide a bitstream. The quality of a video stream provided by an encoder is generally determined by the encoding methodology employed by the encoder.

### BRIEF DESCRIPTION OF THE DRAWINGS

FIG. 1 is a schematic diagram of a network abstraction layer block (NALB) according to an embodiment of the invention.

FIG. 2 is a schematic diagram of an encoder according to an embodiment of the invention.

FIG. 3 is a schematic diagram of a padding apparatus according to an embodiment of the invention.

FIG. 4 is a schematic diagram of an encoding system according to an embodiment of the invention.

FIG. 5 is a schematic diagram of an encoding system according to an embodiment of the invention.

FIG. 6 is a schematic diagram of an encoding system according to an embodiment of the invention.

FIG. 7 is a schematic diagram of an encoding system according to an embodiment of the invention.

FIG. 8 is a schematic diagram of an encoding system according to an embodiment of the invention.

FIG. 9 is a schematic diagram of a decoder according to an embodiment of the invention.

FIG. 10 is a schematic diagram of a padding removal apparatus according to an embodiment of the invention.

FIG. 11 is a schematic diagram of a padding removal apparatus according to an embodiment of the invention.

FIG. 12 is a schematic diagram of a padding removal apparatus according to an embodiment of the invention.

FIG. 13 is a schematic diagram of a padding removal apparatus according to an embodiment of the invention.

### DETAILED DESCRIPTION

Examples of methods and apparatuses for inserting and removing stuffing data in a bitstream are disclosed herein. As will be explained in more detail below, inserting stuffing data in a bitstream may adjust the quality of a video signal included in the bitstream. Certain details are set forth below to provide a sufficient understanding of embodiments of the invention. However, it will be clear to one having skill in the art that embodiments of the invention may be practiced without these particular details, or with additional or different details. Moreover, the particular embodiments of the present invention described herein are provided by way of example and should not be used to limit the scope of the invention to these particular embodiments. In other instances, well-known video components, encoder or decoder components, circuits, control signals, timing protocols, and software operations have not been shown in detail in order to avoid unnecessarily obscuring the invention.

Consumers of video content may have varying tolerance for video quality. Broadcasters therefore may desire varying levels of video quality from an encoder and typically pay for encoding in accordance with their broadcasted level of video quality. That is, the higher the video quality provided by an encoder, the more costly the encoder or licensed use of the encoder. However, designing an encoder for each required level of video quality can be impractical due to the need to re-design an encoding methodology for each level of quality to be made available. It is instead preferable to use a same encoder for each level of video quality, a functionality that may be provided in accordance with embodiments of the present invention. An encoder may, for example, be configured to provide a predetermined video quality using an encoding methodology that is capable of a higher video quality, thereby providing a broadcaster with the appropriate level of video quality.

Bit stuffing has been used to fill bitrates of video encoders. Encoded data may be provided by an encoded and the bitstream “stuffed” with data unrelated to the video data in order to achieve a required bit rate. Briefly, bit stuffing comprises inserting additional data into a bitstream to increase the number of bits in a bitstream relative to the number of bits of encoded video data. While this approach has been successful in filling bit rates, the added data may easily be removed by simply identifying the stuffed bits. Consequently, if stuffed bits are relatively easy to identify, broadcasters may identify and remove bit stuffing from a bitstream to increase video quality, often beyond that which an encoder was intended to produce.

Embodiments of the present invention may provide encoding methodologies using bit stuffing where the extra data stuffed into the bitstream may be difficult to identify, and therefore difficult to remove. By employing bit stuffing methods described herein, encoders may be provided that produce a bit stream of encoded video data having a lower quality than a quality attainable using the encoding methodology of the encoder. In this manner, a same encoder may be configured for encoding at different quality levels.

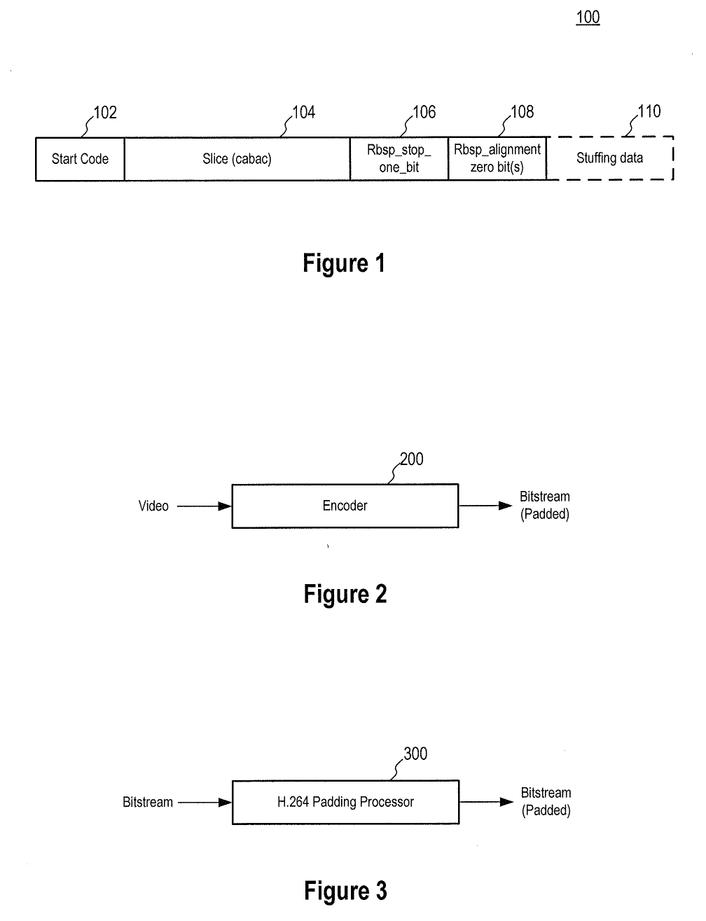

FIG. 1 is a schematic diagram of a network abstraction layer block (NALB) 100 according to an embodiment of the invention. The NALB 100 is generally a block of bits and may be a NALB in accordance with the H.264 coding standard, and may include data encoded using the context-adaptive binary arithmetic coding (CABAC) encoding technique. The NALB 100 may include a start code 102, a slice 104, a stop bit 106, and alignment bits 108. The start code 102 may be implemented using any of a number of predetermined data patterns that identify a beginning of the NALB 100. The slice 104 may follow the start code 102 and may be data (e.g., encoded data) corresponding to a frame or a portion of a frame of a video signal. The stop bit 106 may follow the slice 104 and may identify the end of the slice 104. Finally, the alignment bits 108 may follow the stop bit 106 and increase the bit length of the NALB 100 such that the NALB 100 has byte alignment. Any number of alignment bits 108 and/or bit pattern may be used and, in one example, 0-7 alignment zero bits may be provided.

The NALB 100 may further include stuffing data 110 that, for example, may be appended to the alignment bits 108. The stuffing data 110 may have any bit length and may be implemented using encoded and/or encrypted data. In one embodiment, the stuffing data 110 may be implemented using any pattern of data, except for patterns comprising a start code. For example, the stuffing data 110 may include random data, encrypted data, and/or side band data. The side band data may, for instance, identify an encoder or video source, for instance, with a serial number or proof of origin (e.g., watermark), and may include a video signal, one or more encryption or decryption keys, a license number, and/or a pointer indicating the location of the stuffing data in a NALB. As will be explained in more detail below, stuffing data may be included in one or more NALBs of a bitstream, such as the NALB 100, to adjust (e.g., decrease) the quality of a video signal. In particular, because the stuffing data of each NALB may be random and/or encrypted, the stuffing data may be indistinguishable from other data in a NALB, such as alignment bits or the slice 104. This may, for example, prevent matching methods from identifying and/or removing stuffing data in a bitstream.

FIG. 2 is a schematic diagram of an encoder 200 according to an embodiment of the invention. The encoder 200 may include one or more logic circuits, control logic, logic gates, processors, memory, and/or any combination or sub-combination of the same, and may be configured to encode and/or compress a video signal using one or more encoding techniques, examples of which will be described further below. The encoder 200 may be implemented in any of a variety of devices employing video encoding, including but not limited to, televisions, broadcast systems, mobile devices, tablets, and both laptop and desktop computers, and may be operated in hardware, software, or combinations thereof. In at least one embodiment, the encoder 200 may include an entropy encoder, such as a CABAC encoder, and/or may be configured to encode data, for instance, at a slice level or a macroblock level. The encoder 200 may be configured to provide a bitstream having a constant bit rate or may be configured to provide a bitstream having a variable bit rate.

In an example operation, the encoder 200 may receive and encode a video signal in accordance with one or more encoding techniques (e.g., CABAC) to provide a bitstream that may, for instance, comprise one or more NALBs, such as the NALB 100 of FIG. 1. The encoder 200 may further insert stuffing data, such as the stuffing data 110 of FIG. 1, into one or more of the NALBs, and thereby provide a padded bitstream. The encoder 200 may be configured to insert a varying amount of stuffing data in each NALB or a same amount. In one embodiment, the encoder 200 may perform a bitstuffing method in accordance with embodiments of the present invention and be configured to encode the video signal into a padded bitstream. For example, each NALB may be generated with stuffing data.

In another embodiment, the encoder 200 may be configured to encode the video signal to generate a bitstream and stuffing data may subsequently be added to each NALB. For example, with reference to FIG. 3, the encoder 200 may include a padding apparatus, such as the padding apparatus 300, that may add stuffing data to each NALB of a bitstream to provide a padded bitstream. As discussed, including stuffing data in a bitstream may reduce the quality of a video signal by reducing the bit rate of a video signal for a given bit rate of a bitstream. The amount of stuffing data added may be predetermined, variable, and/or based on the video signal provided to the encoder 200. In one embodiment, for example, the amount of stuffing data added may be determined by control logic in the encoder 200 or another device, such as a controller. Because the encoder 200 may insert any amount of stuffing data into a NALB, the encoder 200 may reduce the bit rate of a video signal by any desired bit amount. Accordingly the encoder 200, may be configured to provide one or more various levels of video signal quality.

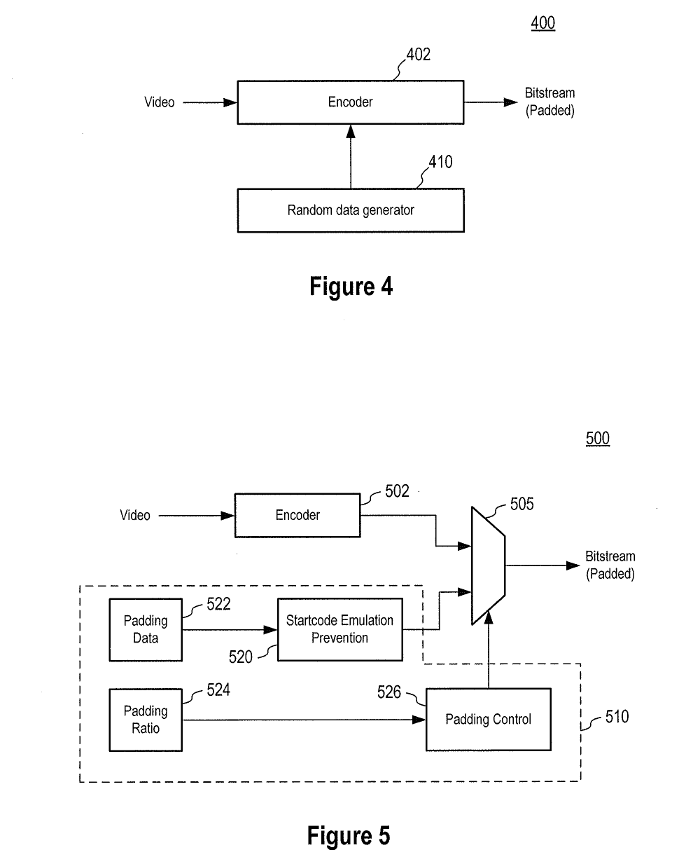

FIG. 4 is a schematic diagram of an encoding system 400 according to an embodiment of the invention. The encoding system 400 may be used to implement the encoder 200 of FIG. 2 and may include an encoder 402 and a random data generator 410. The encoder 402 may be coupled to the random data generator 410 and may receive a video signal and provide a padded bitstream as described above. The encoder 402 may further receive a bitstream of random data from the random data generator 410.

In an example operation of the encoding system 400, the encoder 402 may receive a video signal, and may further receive a bitstream of random data from the random data generator 410. Aside from start codes, the bitstream of random data may comprise any pattern of data and may be generated using any technique for generating random data known in the art, known now or in the future. The encoder 402 may generate NALBs based on the video signal and in at least one embodiment, may insert bits of the random data in each NALB as stuffing data. As described, stuffing data may be inserted in each NALB either during or after the generation of each slice.

FIG. 5 is a schematic diagram of an encoding system 500 according to an embodiment of the invention. The encoding system 500 may used to implement the encoding system 400 of FIG. 4 and may include an encoder 502, a random data generator 510, and a multiplexer 505. The encoder 502 may be configured to receive a video signal and provide a bitstream to a first input of the multiplexer 505. The random data generator 510 may be configured to provide a bitstream of random data to a second input of the multiplexer 505 and a padding control signal to a control input of the multiplexer 505 that may be toggled to selectively control the output of the multiplexer 505. In particular, the random data generator 510 may include a padding data block 522, a start code filter 520, a padding ratio block 524, and a padding control block 526. The start code filter 520 may be coupled to the padding data block 522 and the second input of the multiplexer 505. The padding control block 526 may be coupled to the padding ratio block 524 and the control input of the multiplexer 505.

In an example operation of the encoding system 500, a video signal may be coupled to the encoder 502. Based on the video signal, the encoder 502 may sequentially provide a bitstream including one or more NALBs to the first input of the multiplexer 505. The padding data block 522 may generate a bitstream of random data that may be provided to the start code filter 520, and in turn the start code filter 520 may detect, alter, and/or remove any start codes in the bitstream of random data. The resulting filtered bitstream may be provided to the second input of the multiplexer 505. Further, the padding ratio block 524 may provide a ratio control signal indicative of a bit ratio between a number of bits of a NALB and a number of bits of random data. The padding control block 526 may receive the ratio control signal and toggle the output of the multiplexer 505 to selectively output the bitstream provided by the encoder 502 and random data. As illustrated in FIG. 5, the random data generator 510 may include the padding ratio block 524 and padding control block 526. In other embodiments, the padding ratio block 524 and/or the padding control block 526 may be included in the encoder 502 or may be included in other devices, such as devices located externally relative to the encoding system 500. The padding ratio block 542, the padding control block 526, as well as other blocks described herein may be implemented in hardware, software, or combinations thereof.

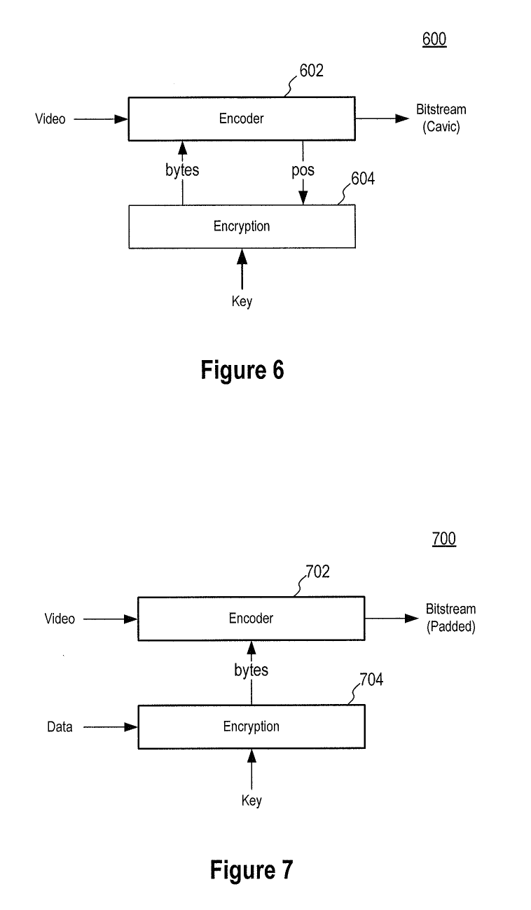

FIG. 6 is a schematic diagram of an encoding system 600 according to an embodiment of the invention. The encoding system 600 may be used to implement the encoder 200 of FIG. 2 and may include an encoder 602 and an encryption block 604. The encoder 602 may be coupled to the encryption block 604 and may receive a video signal and provide a padded bitstream based on the video signal. The encryption block 604 may be configured to receive a pointer from the encoder 602 that may indicate a location of stuffing data in a NALB, for instance, relative to the start code. In one embodiment, the stuffing data in each of the NALBs generated by encoder 602 may be random, as described above. The encryption block 604 may further encrypt the pointer using an encryption key and provide the encrypted pointer to the encoder 602, which may append the encrypted pointer to the stuffing data in the NALB. The encryption block 604 may receive the encryption key, for example, from a key generator (not shown) or a memory device (not shown), such as a non-volatile memory device, and/or may store the encryption key.

As discussed, in some cases stuffing data included in one or more NALBs of a bitstream may include side band data. FIG. 7 is a schematic diagram of an encoding system 700 according to an embodiment of the invention. The encoding system 700 may be used to implement the encoder of FIG. 2 and may include an encoder 702 and an encryption block 704. The encoder 702 may be coupled to the encryption block 704 may provide a padded bitstream based on a video signal. The encryption block 704 may receive data (e.g., side band data) from one or more devices, such as the encoder 602 or an external controller. The encryption block 704 may further encrypt the data using an encryption key, and provide the encrypted data to the encoder 702. In one embodiment, the encryption block 704 may receive the key from a device, such as a memory device, and/or may store the encryption key. The encoder 602 may include the encrypted data in one or more of the NALBs of the padded bitstream.

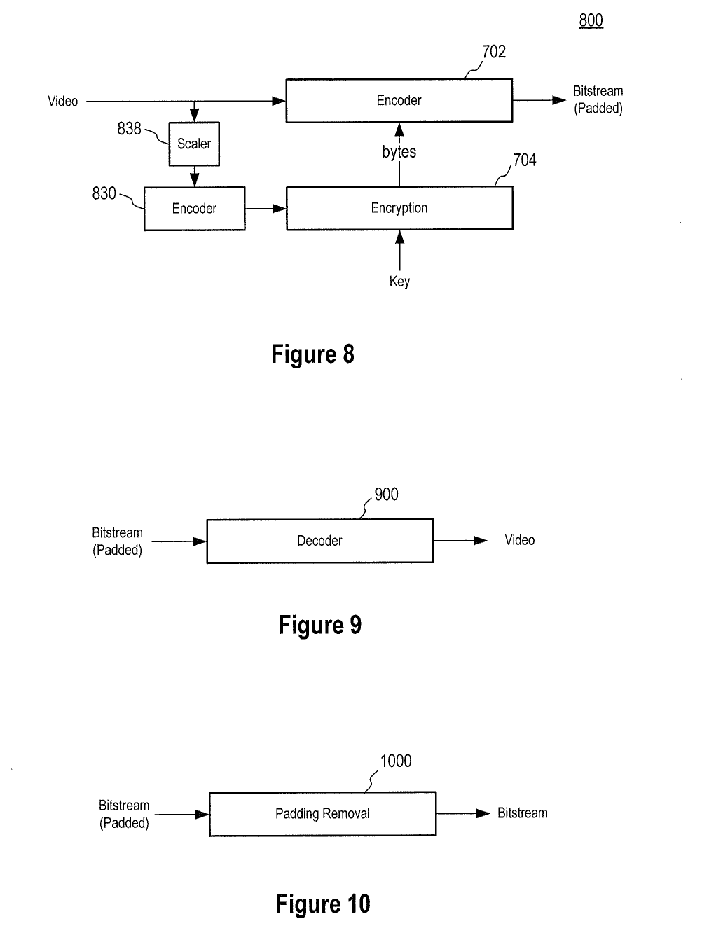

FIG. 8 is a schematic diagram of an encoding system 800 according to an embodiment of the invention. The encoding system 800 includes elements that have been previously described with respect to the encoder 700 of FIG. 7. Those elements have been identified in FIG. 8 using the same reference numbers used in FIG. 7 and operation of the common elements is as previously described. Consequently, a detailed description of the operation of these elements will not be repeated in the interest of brevity.

The encoding system 800 may further include an encoder 830 and a scaler 838. The scaler 838 may be coupled to the encoder 830 and may receive the video stream and provide an adjusted (e.g., scaled) video stream. In one embodiment, for example, the scaler 838 may be configured to lower the resolution of a video signal. The encoder 830 may further be coupled to the encryption block 704.

In an example operation of the encoding system 800, both the encoder 702 and the scaler 838 may receive a video stream. The scaler 838 may adjust the resolution of the video stream and provide the adjusted video stream to the encoder 830. The adjusted video stream may be encoded by the encoder 830 and provided as a bitstream to the encryption block 704. The bitstream may be encrypted by the encryption block 704 using the encryption key and the resulting encrypted bitstream may be provided to the encoder 702. The encoder 702 may generate a bitstream based on the video signal and include the encrypted bitstream as stuffing data.

As described, stuffing data included in a NALB may be random and/or encrypted, causing the stuffing data of a bitstream to be indistinguishable from the remaining data in the bitstream. This may, for instance, prevent or increase the difficulty for a matching methodology from identifying and/or removing the stuffing data. However, in some cases, it may be desirable to remove stuffing data from a padded bitstream, for example, to increase available channel capacity. Thus, as will be explained in more detail below, decoding and/or parsing techniques, such as those based on the H.264 coding standard, may be used to determine the location of a slice and/or stuffing data in example NALBs in accordance with embodiments of the present invention. Once the location of the stuffing data is known, the stuffing data may be removed. Because the stuffing data has been inserted after the stop bit, e.g. the stop bit 106 of FIG. 1, a conventional decoder with a capability to decode video data that was encoded using the encoding methodology of any of the encoders described herein may be used to decode the video data as normal. The decoder is agnostic to the presence of the stuffing bits. However, to recover the video quality, the stuffing bits would need to be removed and the non-stuffed bitstream re-sent to a decoder.

FIG. 9 is a schematic diagram of a decoder 900 according to an embodiment of the invention. The decoder 900 may be implemented in any of a variety of devices employing video decoding, including but not limited to, televisions, broadcast systems, mobile devices, and both laptop and desktop computers. The decoder 900 may include one or more logic circuits, control logic, logic gates, processors, memory, and/or any combination or sub-combination of the same, and may be configured to decode and/or decompress a bitstream using one or more decoding techniques. Moreover, the decoder 900 may be operated in hardware, software, or combinations thereof.

The decoder 900 may be configured to receive a bitstream, such as a padded bitstream, and provide a video signal based on the bitstream. In particular, the decoder 900 may receive and decode a bitstream encoded in accordance with one or more coding standards, such as the H.264 coding standard, and in particular may be configured to decode CABAC encoded bitstreams.

In one embodiment, the decoder 900 may be configured to remove (e.g., discard) stuffing data and decode a padded bitstream in a single decoding operation. In another embodiment, the decoder 900 may be configured to generate a bitstream with stuffing data removed and subsequently decode the bitstream to provide the video signal. For example, with reference to FIG. 10, a padded bitstream may be provided to a padding removal apparatus, such as the padding removal apparatus 1000. The padding removal apparatus 1000 may be configured to remove stuffing data from each NALB of a padded bitstream and subsequently provide a bitstream. In some embodiments, the padding apparatus 1000 may be included in a decoder, such as the decoder 900 of FIG. 9, or may be coupled to the input of a decoder.

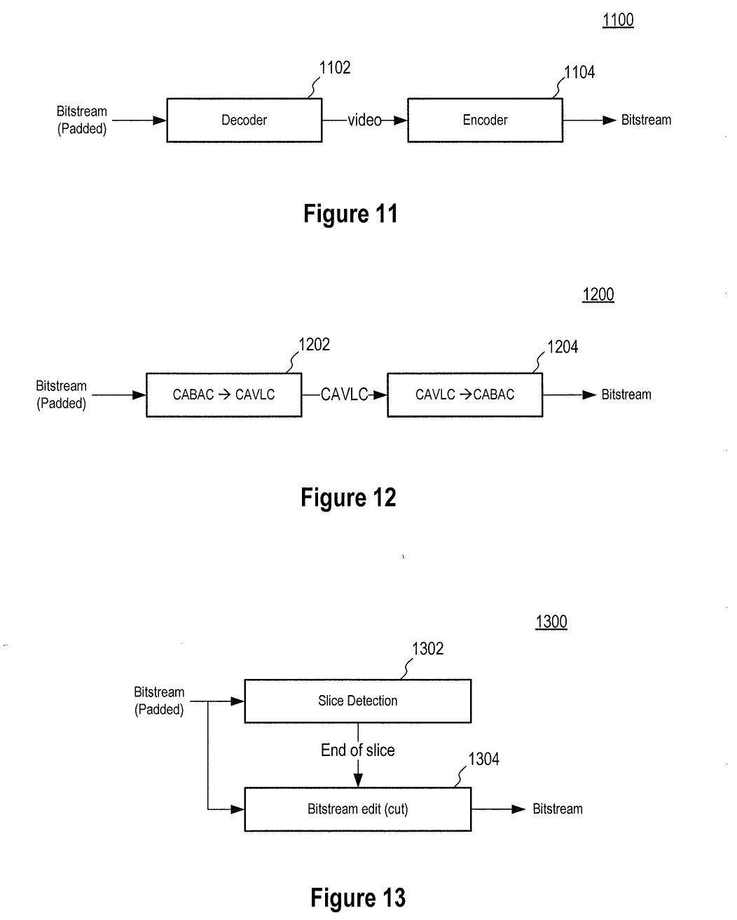

FIG. 11 is a schematic diagram of a padding removal apparatus 1100 according to an embodiment of the invention. The padding removal apparatus 1100 may be used to implement the padding removal apparatus 1000 of FIG. 10 and may include a decoder 1102 and an encoder 1104. The decoder 1102 may receive a padded bitstream and decode the bitstream to provide a video signal based on the bitstream. The encoder 1104 may be configured to receive the video signal and encode the video signal, thereby providing a bitstream without the stuffing data. Note that, in some examples, because the stuffing data is data having a high entropy, and may not be readily recognized in a NALB, the decoder 1102 may completely decode the bitstream in order to recover a data stream without the stuffing data. This is in contrast to systems where the stuffing data may be identified and removed from the data stream without decoding.

In one embodiment, the decoder 1102 and the encoder 1104 may be configured to independently perform decoding and encoding operations, respectively. In another embodiment, the decoder 1102 may be configured to provide encoding decisions, such as motion prediction and inverse quantization, to the encoder 1104, which may encode the video signal based on the encoding decisions.

FIG. 12 is a schematic diagram of a padding removal apparatus 1200 according to an embodiment of the invention. The padding removal apparatus 1200 may be used to implement the padding removal apparatus 1000 of FIG. 10 and may include a transcoder 1202 and a transcoder 1204. The transcoder 1202 may receive a padded bitstream encoded, in whole or in part, with a first encoding standard, such as CABAC, and transcode the bitstream to a second encoding standard, such as CAVLC. The transcoder 1204 may be coupled to the transcoder 1202 and may receive the transcoded bitstream and reverse the transcoding of the transcoder 1202.

As described, a padded bitstream may be decoded or parsed to determine the location of slices and/or stuffing data, and as known, transcoding a bitstream may include a parsing operation. Thus, in at least one embodiment, the transcoder 1202 may locate and remove the stuffing data while transcoding the padded bitstream. Because the transcoded bitstream may not comprise the stuffing data, in reversing the transcoding of the transcoder 1202, the transcoder 1204 may provide a bitstream without the stuffing data.

FIG. 13 is a schematic diagram of a padding removal apparatus 1300 according to an embodiment of the invention. The padding removal apparatus 1300 may be used to implement the padding removal apparatus 1000 of FIG. 10 and may include a slice detection block 1302 and a bitstream editor 1304 that each receive a same padded bitstream. For each NALB in the padded bitstream, the slice detection block 1302 may identify the location of a slice and/or stuffing data and may provide a control signal to the bitstream editor 1304 indicating the location of the slice and/or stuffing data. The bitstream editor 1304 may receive the control signal and remove one or more bits of the padded bitstream based on the control signal. In one embodiment, for example, the bitstream editor 1304 may remove all bits from a time the control signal is received to a time a start code of a subsequent NALB is received.

In at least one embodiment, the slice detection block 1302 may include a decoder and may decode the padded bitstream. In decoding the bitstream, the slice detection block 1302 may determine the location of a slice and/or stuffing data for each NALB and provide respective control signals, as described above. In another embodiment, the slice detection block 1302 may comprise a parser, such as a CABAC parser, and may parse the padded bitstream to determine the location of a slice and/or stuffing data for each NALB. In embodiments where the stuffing data includes encrypted pointers, as described above, the slice detection block 1302 may include a decryption block and may decrypt an encrypted pointer in each NALB with a decryption key to determine location of a slice and/or stuffing data in each NALB. The decryption key may correspond to an encryption key of an encryption block, such as an encryption key of the encryption block 604 of FIG. 6.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. An encoding system, comprising:
an encoder configured to receive a video signal and stuffing data and encode the video signal in accordance with an encoding methodology, the encoder further configured to provide a bitstream including the encoded video signal and the stuffing data;
wherein the stuffing data includes random data, encrypted data, or combinations thereof.

2. The encoding system of claim 1, wherein the encoder is further configured to insert the stuffing data into the bitstream responsive, at least in part, to encoding the video signal.

3. The encoding system of claim 1, wherein the stuffing data comprises side band data.

4. The encoding system of claim 1, wherein the encoder is a first encoder and the bitstream is a first bitstream, the encoding system further comprising:
a scaler configured to receive the video signal and provide an adjusted video signal based, at least in part, on the video signal;
a second encoder coupled to the scaler and configured to receive the adjusted video signal and generate a second bitstream; and
an encryption block coupled to the first and second encoders, wherein the encryption block is configured to receive the second bitstream, the encryption block further configured to encrypt the second bitstream and provide the encrypted second bitstream to the first encoder; and
wherein the stuffing data includes the encrypted second bitstream.

5. The encoding system of claim 1, wherein the encoding methodology is in accordance with an H.264 coding standard.

6. A padding removal apparatus, comprising:
a slice detection block configured to receive a bitstream, decode the bitstream, and determine a location of stuffing data in the bitstream, the slice detection block further configured to provide a control signal indicative of the location; and
a bitstream editor coupled to the slice detection block and configured to receive the bitstream and the control signal, the bitstream editor further configured to remove one or more bits of the stuffing data of the bitstream based, at least in part, on the control signal.

7. The padding removal apparatus of claim 6, wherein the slice detection block is configured to parse the padded bitstream in accordance with the H.264 coding standard.

8. The padding removal apparatus of claim 6, wherein the slice detection block comprises a decryption block and is configured to determine the location of the stuffing data responsive, at least in part, to decrypting an encrypted pointer.

9. The padding removal apparatus of claim 6, wherein the stuffing data includes encrypted data.

10. A padding removal apparatus, comprising:
a first transcoder configured to receive a first bitstream in accordance with a first coding standard and locate and remove stuffing data from the first bitstream responsive, at least in part, to receipt of the first bitstream, the first transcoder further configured to provide a second bitstream in accordance with a second coding standard based, at least in part, on the first bitstream; and
a second transcoder coupled to the first transcoder and configured to receive the second bitstream and provide a third bitstream in accordance with the first coding standard based on the second bitstream.

11. The padding removal apparatus of claim 10, wherein the first coding standard comprises CABAC encoding.

12. The padding removal apparatus of claim 10, wherein the first transcoder is further configured to locate the stuffing data responsive, at least in part, to parsing the first bitstream.

13. A method, comprising:
receiving a video signal and stuffing data at an encoder;
encoding the video signal in accordance with the H.264 coding standard to provide a first bitstream; and
providing a second bitstream including the first bitstream and the stuffing data;
wherein the stuffing data comprises at least one of random data, encrypted data, or combinations thereof.

14. The method of claim 13, wherein the stuffing data does not include start codes as identified by the coding standard.

15. The method of claim 13, wherein an amount of the stuffing data is based, at least in part, on a ratio control signal.

16. The method of claim 13, wherein said providing a second bitstream, comprises:
inserting the stuffing data into the first bitstream.

17. The method of claim 13, wherein the second bitstream is CAVLC encoded.

18. A method, comprising:
receiving a padded bitstream;
determining the location of each of a plurality of slices in the padded bitstream;
generating a plurality of control signals corresponding to the location of each of the plurality of slices, respectively; and
removing one or more bits of the padded bitstream based, at least in part, on the each of the plurality of control signals.

19. The method of claim 18, wherein said determining comprises:
parsing the padded bitstream.

20. The method of claim 18, further comprising:
decrypting a pointer.

21. The method of claim 18, wherein the padded bitstream comprises CABAC encoded data.

22. The method of claim 18, wherein said removing comprises:
providing a bitstream responsive, at least in part, to receipt of a start code; and
not providing a bitstream responsive, at least in part, to receipt of one of the plurality of control signals.

23. A method, comprising:
receiving a first bitstream comprising stuffing data;
decoding the first bitstream with a decoder to generate a video signal; and
encoding the video signal with an encoder to generate a second bitstream;
wherein the stuffing data comprises at least one of random data or encrypted data.

24. The method of claim 23, further comprising:
providing encoding decisions from the decoder to the encoder.

25. The method of claim 23, wherein the first bitstream comprises at least one of random stuffing data or encrypted stuffing data, wherein the second bitstream does not comprise stuffing data.

26. The method of claim 23, wherein the first bitstream has a first bit rate and the second bitstream has a second bit rate, wherein the first bit rate is greater than the second bit rate.
